(19) United States
(12) Patent Application Publication
(10) Pub. No.: US 2012/0158430 A1
(43) Pub. Date: Jun. 21, 2012

(54) SYSTEMS AND METHODS FOR PATIENT PRESCRIPTION MANAGEMENT

(75) Inventor: Mary Louise MacDonald, Boston, MA (US)

(73) Assignee: General Electric Company, Schenectady, NY (US)

(21) Appl. No.: 12/975,066

(22) Filed: Dec. 21, 2010

(51) Int. Cl. G06Q 50/00; G06Q 10/00; G06Q 90/00

(52) U.S. Cl. 705/3; 705/500

(57) ABSTRACT

An example method for patient prescription management. The method includes obtaining a plurality of prescriptions associated with a patient, wherein each prescription contains an order for a prescribed medication. The method includes compiling the plurality of prescriptions into a single prescription order. The method includes identifying a pharmacy that carries the prescribed medications of the single prescription order based on a location of the patient. The method includes submitting the single prescription order to the identified pharmacy to facilitate a single delivery or a single pickup of the medications.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND

Healthcare environments, such as hospitals or clinics, include information systems, such as healthcare information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient prescription orders, medical histories, imaging data, test results, diagnosis information, management information, and/or scheduling information, for example.

Patients receive prescriptions from healthcare professionals for medications associated with a variety of medical conditions. Often times, patients are prescribed different medications from different healthcare providers. Many patients, especially those suffering from less common and/or more serious medical conditions, must search for pharmacies that have their prescribed medications stocked and available. Frequently, to fill all of the medication orders that have been prescribed, these patients have to visit multiple pharmacies and/or special order medications.

### BRIEF SUMMARY

Certain examples provide methods, apparatus, and articles of manufacture for patient prescription management.

Certain examples provide a method for patient prescription management. The method includes obtaining a plurality of prescriptions associated with a patient, wherein each prescription contains an order for a prescribed medication. The method includes compiling the plurality of prescriptions into a single prescription order. The method includes identifying a pharmacy that carries the prescribed medications of the single prescription order based on a location of the patient. The method includes submitting the single prescription order to the identified pharmacy to facilitate a single delivery or a single pickup of the medications.

Certain examples provide a patient prescription management system. The system includes a prescription organizer to obtain a plurality of prescriptions associated with a patient, each prescription to contain an order for a prescribed medication, the prescription organizer to compile the plurality of prescriptions into a single prescription order. The system includes a pharmacy analyzer to identify a pharmacy that carries the prescribed medications of the single prescription order based on a location of the patient. The system includes a prescription submitter to submit the single prescription order to the identified pharmacy to facilitate a single delivery or a single pickup of the medications.

Certain examples provide a tangible computer readable medium having a set of instructions for execution on a processing device, the set of instructions implementing a method for patient prescription management. The method includes obtaining a plurality of prescriptions associated with a patient, wherein each prescription contains an order for a prescribed medication. The method includes compiling the plurality of prescriptions into a single prescription order. The method includes identifying a pharmacy that carries the prescribed medications of the single prescription order based on a location of the patient. The method includes submitting the single prescription order to the identified pharmacy to facilitate a single delivery or a single pickup of the medications.

### BRIEF DESCRIPTION OF SEVERAL VIEWS OF THE DRAWINGS

FIG. 1 illustrates a block diagram of an example healthcare system.

FIG. 2 illustrates an example pharmaceutical organizer of FIG. 1.

FIG. 3 illustrates a flow diagram for an example method of patient prescription management.

FIG. 4 shows a block diagram of an example processor system that may be used to implement systems and methods described herein.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EXAMPLES

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, in an embodiment, at least one of the elements is hereby expressly defined to include a tangible medium such as a memory, DVD, CD, Blu-ray, etc., storing the software and/or firmware.

In certain examples, prescriptions associated with a patient are stored in a healthcare system. The prescriptions include orders for medications that have been prescribed to the patient by a plurality of healthcare providers.

In certain examples, the healthcare system includes a pharmaceutical organizer. The pharmaceutical organizer is connected to a healthcare information system to obtain the prescriptions associated with the patient. The pharmaceutical organizer compiles the prescriptions into a single prescription order that contains all the medications that have been prescribed to the patient. The pharmaceutical organizer is also connected to a network with access to a plurality of pharmacies. These pharmacies send the pharmaceutical organizer medication information and availability via the network. The pharmaceutical organizer uses the single prescription order and the medication information and availability to identify a single pharmacy that is capable of providing all of the prescribed medications to the patient.

In identifying a single pharmacy that is capable of providing all of the prescribed medications to the patient, certain examples consider a location of the user, such as the patient's residence, to facilitate the most convenient pickup or delivery of the medication. To consider the patient's location, the pharmacy analyzer utilizes one of a terminal identification, wireless fidelity, global positioning system, or radio frequency identification tag, or considers a patient request for a particular location.

In certain examples, the pharmacy analyzer submits the single prescription order to the identified pharmacy. Identifying a single pharmacy that can meet the needs of the patient facilitates an efficient and convenient prescription filling process that requires only one pickup or delivery of the prescribed medications.

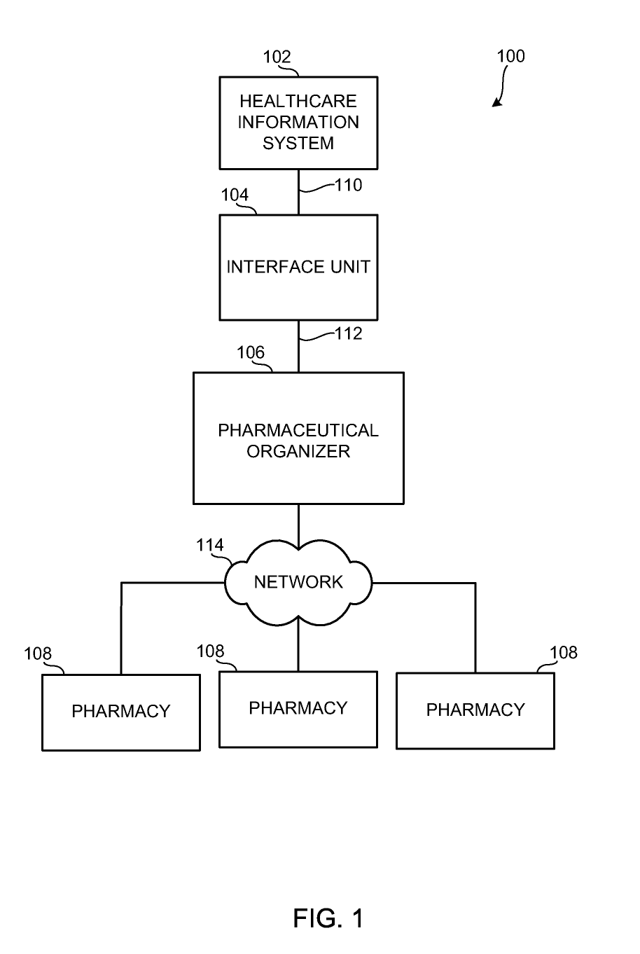

FIG. 1 shows a block diagram of an example healthcare system 100 capable of implementing the example methods and systems described herein. The example healthcare system 100 includes a healthcare information system (HIS) 102, an interface unit 104, a pharmaceutical organizer 106, and a plurality of pharmacies 108.

In the illustrated example, the HIS 102 is housed in a healthcare facility and locally archived. However, in other implementations, the HIS 102 can be housed in one or more other suitable locations. In certain implementations, the HIS 102 can be implemented remotely via a thin client and/or downloadable software solution. Information (e.g., prescription orders, scheduling, test results, observations, diagnosis, etc.) can be entered into the HIS 102 by healthcare providers (e.g., radiologists, physicians, and/or technicians) before and/or after patient examination. The HIS 102 stores medical information such as prescription orders, clinical reports, patient information, and/or administrative information received from, for example, personnel at a hospital, clinic, and/or a physician's office. In certain examples, the HIS 102 can be implemented in and/or in conjunction with one or more of a PACS, RIS, EMR, CIS, CVIS, LIS, etc.

The interface unit 104 includes a healthcare information system interface connection 110 and a pharmaceutical organizer interface connection 112. The interface unit 104 facilities communication between the HIS 102 and the pharmaceutical organizer 106. The interface connection 110 can be implemented by, for example, a Wide Area Network (“WAN”) such as a private network or the Internet. Accordingly, the interface unit 104 includes one or more communication components such as, for example, an Ethernet device, an asynchronous transfer mode (“ATM”) device, an 802.11 device, a DSL modem, a cable modem, a cellular modem, etc.

In turn, the pharmaceutical organizer 106 communicates with the plurality of pharmacies 108 via a network 114. The pharmaceutical organizer 108 may be implemented at a plurality of locations (e.g., a hospital, clinic, doctor's office, other medical office, assisted living facility, insurance company office, patient residence or terminal, etc.). The network 114 is implemented by, for example, the Internet, an intranet, a private network, a wired or wireless Local Area Network, and/or a wired or wireless Wide Area Network. The plurality of pharmacies 108 contain medication information, such as medication availability, associated with each pharmacy.

In operation, the interface unit 104 receives prescription orders from the HIS 102 via the interface connection 110. If necessary (e.g., when different formats of the received information are incompatible), the interface unit 110 translates or reformats (e.g., into Structured Query Language (“SQL”) or standard text) the prescription orders to be properly stored at the pharmaceutical organizer 106. The reformatted prescription orders can be transmitted using a transmission protocol to enable different prescription orders to share common identification elements, such as a patient name or social security number. Next, the interface unit 104 transmits the prescription orders to the pharmaceutical organizer 106 via the pharmaceutical organizer interface connection 112. Finally, prescription orders are stored in the pharmaceutical organizer 106.

The pharmaceutical organizer 106 can be any equipment (e.g., a personal computer, a tablet, a handheld scanner, etc.) capable of executing software that permits electronic data (e.g., prescription orders) to be acquired, stored, or transmitted for operation. As shown in FIG. 1, the pharmaceutical organizer 106 is connected to the network 114 and, thus, can communicate with the plurality of pharmacies 108, and/or any other device coupled to the network 114. In the illustrated example, the pharmaceutical organizer 106 is located in a centralized location that can be accessed by a plurality of systems and facilities (e.g., hospitals, clinics, doctor's offices, other medical offices, and/or terminals). In some examples, the pharmaceutical organizer 106 can be spatially distant from the HIS 102. For example, the pharmaceutical organizer 106 can be located at General Electric® headquarters, an insurance company office, and/or a patient residence. Thus, the pharmaceutical organizer 106 can be used by a healthcare provider, a patient, and/or any other party that wishes to facilitate or use a streamlined prescription filling process.

The pharmaceutical organizer 106 receives prescription orders from the HIS 102 via the interface unit 104 and compiles a single prescription order containing all prescribed medications associated with a patient. The pharmaceutical organizer 106 connects to the plurality of pharmacies 108 via the network 114. Pharmacy information, such as medication information and availability, which is stored at the plurality of pharmacies 108, is sent to the pharmaceutical organizer 106 via the network 114. The pharmaceutical organizer 106 uses the single prescription order and the medication information and availability obtained from the plurality of pharmacies 108 to identify a single pharmacy that carries the prescribed medications of the single prescription order based on a location of the patient. The pharmaceutical organizer 106 submits the single prescription order to the identified pharmacy via the network 114 to facilitate a single delivery or a single pickup of all the medications from the single prescription order.

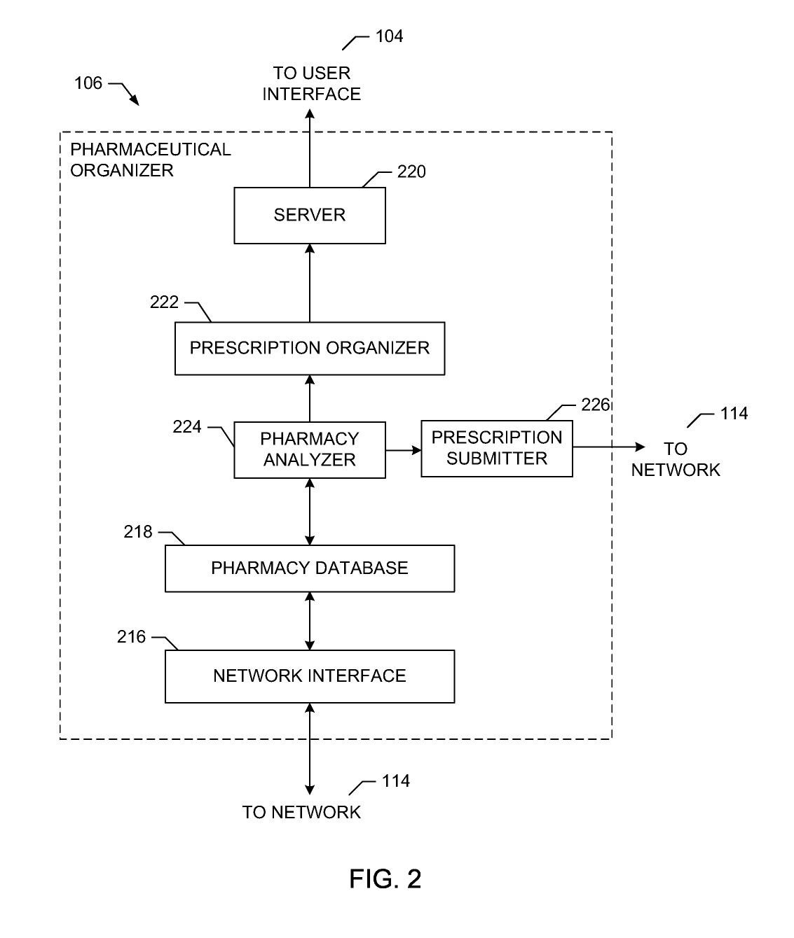

FIG. 2 illustrates an example pharmaceutical organizer 106 of FIG. 1. The pharmaceutical organizer 106 includes a network interface 216, a pharmacy database, 218, a server 220, a prescription organizer 222, a pharmacy analyzer 224, and a prescription submitter 226. The network interface 216 interfaces with the network 114 of FIG. 1 to obtain medication information and availability associated each pharmacy of the plurality of pharmacies 108 of FIG. 1. Via the network interface 216, the pharmacy database 218 stores the medication information and availability.

The server 220 receives, processes, and conveys information, such as prescription orders, to and from the HIS 102 of FIG. 1 via the interface unit 104 of FIG. 1. The prescription organizer 222 obtains a plurality of prescriptions from the server 220 and compiles them into a single prescription order containing all the medications that have been prescribed to a patient by a plurality of healthcare providers.

The pharmacy analyzer 224 obtains the single compiled prescription order from the prescription organizer 222 and uses the pharmacy database 218 to identify a particular pharmacy that carries all the medications included in the single prescription order. In identifying a particular pharmacy that carries and has in stock the medications included in the single prescription order, the pharmacy analyzer 224 considers a location of the patient, such as the patient's residence, to locate the most convenient pharmacy for the patient. To consider the patient's location, the pharmacy analyzer 224 utilizes one of a terminal identification, wireless fidelity, global positioning system, or radio frequency identification tag, or considers a patient request for a particular location.

Once the pharmacy analyzer 224 has identified a particular pharmacy that carries and has in stock the medications included in the single prescription order based on the location of the patient, the prescription submitter 226 submits the prescription order to the particular pharmacy via the network 114 of FIG. 1. Identifying a single pharmacy to meet all the medication needs of the patient allows for a single pickup or delivery of all the prescribed medications.

The network interface 216, pharmacy database, 218, server 220, prescription organizer 222, pharmacy analyzer 224, and prescription submitter 226 can be implemented in software, hardware, firmware, and/or a combination of these elements. The network interface 216, pharmacy database, 218, server 220, prescription organizer 222, pharmacy analyzer 224, and prescription submitter 226 can be implemented separately and/or combined in various forms. The network interface 216, pharmacy database, 218, server 220, prescription organizer 222, pharmacy analyzer 224, and prescription submitter 226 can be implemented as a set of instructions/routines forming machine executable code stored on a machine accessible medium for execution by a computing/processing device, for example.

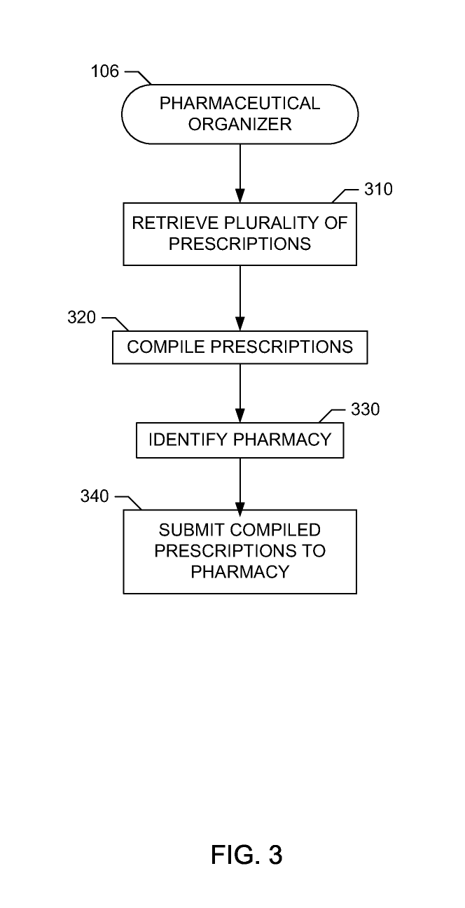

FIG. 3 illustrates a flow diagram for an example method of patient prescription management. The example process(es) of FIG. 3 can be performed using a processor, a controller and/or any other suitable processing device. For example, the example process(es) of FIG. 3 can be implemented using coded instructions (e.g., computer readable instructions) stored on a tangible computer readable medium such as a flash memory, a read-only memory (ROM), and/or a random-access memory (RAM). As used herein, the term tangible computer readable medium is expressly defined to include any type of computer readable storage and to exclude propagating signals. Additionally or alternatively, the example process(es) of FIG. 3 can be implemented using coded instructions (e.g., computer readable instructions) stored on a non-transitory computer readable medium such as a flash memory, a read-only memory (ROM), a random-access memory (RAM), a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example process(es) of FIG. 3 can be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example process(es) of FIG. 3 can be implemented manually or as any combination(s) of any of the foregoing techniques, for example, any combination of firmware, software, discrete logic and/or hardware. Further, although the example process(es) of FIG. 3 are described with reference to the flow diagram of FIG. 3, other methods of implementing the process(es) of FIG. 3 can be employed. For example, the order of execution of the blocks can be changed, and/or some of the blocks described can be changed, eliminated, sub-divided, or combined. Additionally, any or all of the example process(es) of FIG. 3 can be performed sequentially and/or in parallel by, for example, separate processing threads, processors, devices, discrete logic, circuits, etc.

FIG. 3 illustrates a flow diagram for an example method to implement the example pharmaceutical organizer 106 of FIGS. 1-2. At block 310, a plurality of prescriptions associated with a patient is obtained from a healthcare system. Each prescription includes an order for a medication prescribed by a healthcare professional.

At block 320, the plurality of prescriptions is compiled into a single prescription order. This single prescription order contains all the prescribed medications needed by the patient from a plurality of prescribing healthcare professionals.

At block 330, a pharmacy is identified that meets all of the needs of the patient based on the medications in the single prescription order. The pharmacy is identified using a pharmacy database that contains medication information and availability obtained from a plurality of pharmacies. Thus, a pharmacy is identified that has all the prescribed medications stocked and available. Additionally, the pharmacy is identified based on a location of the patient, such as the patient's residence, obtained using one of a terminal identification, wireless fidelity, global positioning system, or radio frequency identification tag, or a patient request for a particular location.

At block 340, the prescription order is submitted to the identified pharmacy via a network. Identifying a single pharmacy to meet all the medication needs of the patient and submitting the prescription order to this identified pharmacy with instructions to consolidate the order allows for a single consolidated pickup or delivery of all the prescribed medications.

One or more of the blocks of the method to implement the example pharmaceutical organizer 106 of FIGS. 1-2 can be implemented alone or in combination in hardware, firmware, and/or as a set of instructions in software, for example. Certain examples can be provided as a set of instructions residing on a computer-readable medium, such as a memory, hard disk, DVD, or CD, for execution on a general purpose computer or other processing device.

Certain examples can omit one or more of these blocks and/or perform the blocks in a different order than the order listed. For example, some steps may not be performed in certain examples. As a further example, certain steps can be performed in a different temporal order, including simultaneously, than listed above.

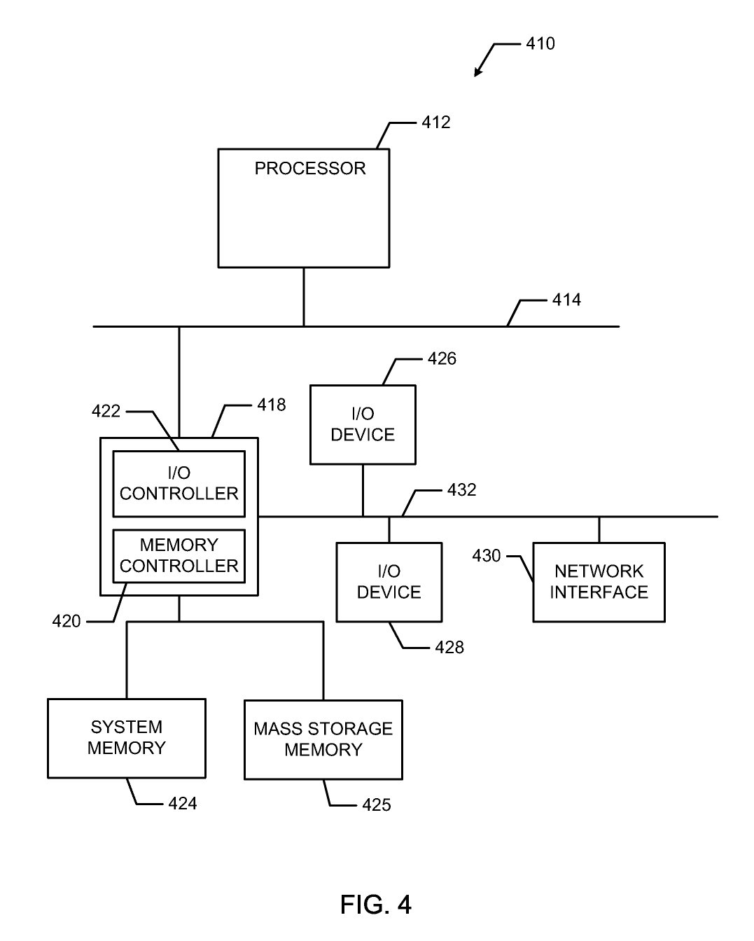

FIG. 4 is a block diagram of an example processor system 410 that can be used to implement systems and methods described herein. As shown in FIG. 4, the processor system 410 includes a processor 412 that is coupled to an interconnection bus 414. The processor 412 can be any suitable processor, processing unit, or microprocessor, for example. Although not shown in FIG. 4, the system 410 can be a multi-processor system and, thus, can include one or more additional processors that are identical or similar to the processor 412 and that are communicatively coupled to the interconnection bus 414.

The processor 412 of FIG. 4 is coupled to a chipset 418, which includes a memory controller 420 and an input/output (“I/O”) controller 422. As is well known, a chipset typically provides I/O and memory management functions as well as a plurality of general purpose and/or special purpose registers, timers, etc. that are accessible or used by one or more processors coupled to the chipset 418. The memory controller 420 performs functions that enable the processor 412 (or processors if there are multiple processors) to access a system memory 424 and a mass storage memory 425.

The system memory 424 can include any desired type of volatile and/or non-volatile memory such as, for example, static random access memory (SRAM), dynamic random access memory (DRAM), flash memory, read-only memory (ROM), etc. The mass storage memory 425 can include any desired type of mass storage device including hard disk drives, optical drives, tape storage devices, etc.

The I/O controller 422 performs functions that enable the processor 412 to communicate with peripheral input/output (“I/O”) devices 426 and 428 and a network interface 430 via an I/O bus 432. The I/O devices 426 and 428 can be any desired type of I/O device such as, for example, a keyboard, a video display or monitor, a mouse, etc. The network interface 430 can be, for example, an Ethernet device, an asynchronous transfer mode (“ATM”) device, an 802.11 device, a DSL modem, a cable modem, a cellular modem, etc. that enables the processor system 410 to communicate with another processor system.

While the memory controller 420 and the I/O controller 422 are depicted in FIG. 4 as separate blocks within the chipset 418, the functions performed by these blocks can be integrated within a single semiconductor circuit or may be implemented using two or more separate integrated circuits.

Thus, certain examples provide for improved patient prescription management to facilitate the medication needs of a patient. Certain examples provide for a plurality of prescriptions from a plurality of healthcare professionals to be compiled and filled at a single pharmacy capable of supplying all of the prescribed medications. Additionally, certain examples provide for patient prescription management based on a location of the user, such as a patient's residence, to facilitate the convenient and efficient filling of prescriptions.

Certain examples contemplate methods, systems and computer program products on any machine-readable media to implement functionality described above. Certain examples can be implemented using an existing computer processor, or by a special purpose computer processor incorporated for this or another purpose or by a hardwired and/or firmware system, for example.

One or more of the components of the systems and/or steps of the methods described above can be implemented alone or in combination in hardware, firmware, and/or as a set of instructions in software, for example. Certain examples can be provided as a set of instructions residing on a computer-readable medium, such as a memory, hard disk, DVD, or CD, for execution on a general purpose computer or other processing device. Certain examples of the present invention can omit one or more of the method steps and/or perform the steps in a different order than the order listed. For example, some steps cannot be performed in certain examples of the present invention. As a further example, certain steps can be performed in a different temporal order, including simultaneously, than listed above.

Certain examples include computer-readable media for carrying or having computer-executable instructions or data structures stored thereon. Such computer-readable media can be any available media that can be accessed by a general purpose or special purpose computer or other machine with a processor. By way of example, such computer-readable media can comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention can be practiced in a networked environment using logical connections to one or more remote computers having processors. Logical connections can include a local area network (LAN) and a wide area network (WAN) that are presented here by way of example and not limitation. Such networking environments are commonplace in office-wide or enterprise-wide computer networks, intranets and the Internet and can use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention can also be practiced in distributed computing environments where tasks are performed by local and remote processing devices that are linked (either by hardwired links, wireless links, or by a combination of hardwired or wireless links) through a communications network. In a distributed computing environment, program modules can be located in both local and remote memory storage devices.

An exemplary system for implementing the overall system or portions of embodiments of the invention might include a general purpose computing device in the form of a computer, including a processing unit, a system memory, and a system bus that couples various system components including the system memory to the processing unit. The system memory can include read only memory (ROM) and random access memory (RAM). The computer can also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated computer-readable media provide nonvolatile storage of computer-executable instructions, data structures, program modules and other data for the computer.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for patient prescription management, said method comprising:
obtaining a plurality of prescriptions associated with a patient, wherein each prescription contains an order for a prescribed medication;
compiling the plurality of prescriptions into a single prescription order;
identifying a pharmacy that carries the prescribed medications of the single prescription order based on a location of the patient;
submitting the single prescription order to the identified pharmacy to facilitate a single delivery or a single pickup of the medications.

2. The method of claim 1, wherein the plurality of prescriptions has been prescribed by a plurality of healthcare providers associated with the patient.

3. The method of claim 1, wherein the plurality of prescriptions has been uploaded to a healthcare information system by a healthcare provider associated with the patient.

4. The method of claim 1, wherein the pharmacy is identified via a pharmacy database.

5. The method of claim 4, wherein the pharmacy database comprises a database containing medication information and availability for pharmacies located in an area.

6. The method of claim 1, wherein identifying a pharmacy that carries the prescribed medications of the single prescription order includes verifying that the pharmacy has the prescribed medications in stock.

7. The method of claim 1, wherein identifying a pharmacy that carries the prescribed medications of the single prescription order based on a location of the patient includes determining the location of the patient using at least one of a terminal identification, wireless fidelity, global positioning system, radio frequency identification tag, or a patient request.

8. A patient prescription management system, said system comprising:
a prescription organizer to obtain a plurality of prescriptions associated with a patient, each prescription to contain an order for a prescribed medication, the prescription organizer to compile the plurality of prescriptions into a single prescription order;
a pharmacy analyzer to identify a pharmacy that carries the prescribed medications of the single prescription order based on a location of the patient; and
a prescription submitter to submit the single prescription order to the identified pharmacy to facilitate a single delivery or a single pickup of the medications.

9. The system of claim 8, wherein the plurality of prescriptions has been prescribed by a plurality of healthcare providers associated with the patient.

10. The system of claim 8, wherein the plurality of prescriptions has been uploaded to a healthcare information system by a healthcare provider associated with the patient.

11. The system of claim 8, wherein the pharmacy is identified via a pharmacy database.

12. The system of claim 11, wherein the pharmacy database comprises a database containing medication information and availability for pharmacies located in an area.

13. The system of claim 8, wherein identifying a pharmacy that carries the prescribed medications of the single prescription order includes verifying that the pharmacy has the prescribed medications in stock.

14. The system of claim 8, wherein identifying a pharmacy that carries the prescribed medications of the single prescription order based on a location of the patient includes determining the location of the patient using at least one of a terminal identification, wireless fidelity, global positioning system, radio frequency identification tag, or a patient request.

15. A tangible computer readable medium having a set of instructions for execution on a device, the set of instructions implementing a method for patient prescription management, said method comprising:
obtaining a plurality of prescriptions associated with a patient, wherein each prescription contains an order for a prescribed medication;
compiling the plurality of prescriptions into a single prescription order;
identifying a pharmacy that carries the prescribed medications of the single prescription order based on a location of the patient;
submitting the single prescription order to the identified pharmacy to facilitate a single delivery or a single pickup of the medications.

16. The computer readable medium of claim 15, wherein the plurality of prescriptions has been prescribed by a plurality of healthcare providers associated with the patient.

17. The computer readable medium of claim 15, wherein the plurality of prescriptions has been uploaded to a healthcare information system by a healthcare provider associated with the patient.

18. The computer readable medium of claim 15, wherein the pharmacy is identified via a pharmacy database.

19. The computer readable medium of claim 18, wherein the pharmacy database comprises a database containing medication information and availability for pharmacies located in an area.

20. The computer readable medium of claim 15, wherein identifying a pharmacy that carries the prescribed medications of the single prescription order includes verifying that the pharmacy has the prescribed medications in stock.

21. The computer readable medium of claim 15, wherein identifying a pharmacy that carries the prescribed medications of the single prescription order based on a location of the patient includes determining the location of the patient using at least one of a terminal identification, wireless fidelity, global positioning system, radio frequency identification tag, or a patient request.
